(19) United States
(12) Patent Application Publication
(10) Pub. No.: US 2026/0122479 A1
(43) Pub. Date: Apr. 30, 2026

(54) SYSTEM PROVIDING INFORMATION ACCORDING TO PROTECTION POLICY OF INFORMATION PROVIDER BY USING PERSONAL DEVICE INCLUDING SMALL LANGUAGE MODEL AND HUB DEVICE INCLUDING LARGE LANGUAGE MODEL

(71) Applicant: Joung Won KIM, Seongnam-si (KR)

(72) Inventor: Joung Won KIM, Seongnam-si (KR)

(21) Appl. No.: 19/368,143

(22) Filed: Oct. 24, 2025

(30) Foreign Application Priority Data
Oct. 24, 2024 (KR) 10-2024-0146261

(51) Int. Cl. H04W 12/02; G06F 16/3329; G10L 15/22; H04W 4/24; H04W 4/80

(52) U.S. Cl. CPC H04W 12/02; G06F 16/3329; G10L 15/22; H04W 4/24; H04W 4/80

(57) ABSTRACT

According to various embodiments, a hub device operating based on Large Language Model (LLM) performs communication with personal devices operating based on Small Language Model (SLM). The hub device may include a first communication module for short-range wireless communication with the personal devices, a second communication module for communication with an external server, and a memory. The hub device may receive first information processed by a first SLM of a first personal device of a first information provider. The hub device may receive second information processed by a second SLM of a second personal device of a second information provider. The hub device may receive a search request including information about an information search scope specified by an information requester from the external server.

### CROSS-REFERENCE TO RELATED APPLICATION

This application claims priority to and the benefit of Korean Patent Application No. 10-2024-0146261, filed on Oct. 24, 2024, the disclosure of which is incorporated herein by reference in its entirety.

### BACKGROUND

### 1. Field of the Invention

Various embodiments of the present disclosure relate to a system, a hub artificial intelligence device, and a personal artificial intelligence device for providing information according to a protection policy of an information provider by using a personal artificial intelligence device including a small language model and a hub artificial intelligence device including a large language model.

### 2. Discussion of Related Art

The AI (Artificial Intelligence) ecosystem is spreading, and a large amount of user data is required to train neural network Model (e.g., Large Language Model or Small Language Model). However, since user data contains personal information, there are restrictions on its use. This is considered a factor hindering the development of the AI ecosystem.

Competition continues as performance improvements in large language neural network model processing are carried out on a mega scale, resulting in the consumption of astronomical amounts of GPUs (Graphic Processing Units) and memory. Consequently, cost efficiency issues and environmental problems due to power consumption are increasingly becoming issues.

### SUMMARY OF THE INVENTION

The present invention aims to propose a method that recognizes an individual's ownership of user data, complies with different individual information protection policies, and can provide user data easily and quickly to those who need the information.

By processing a large language neural network model in a hub device and a small language neural network model in a personal device, the present invention aims to propose a way to enhance personalized services.

To achieve the above objects, a hub device based on Large Language Model (LLM) that communicates with personal devices based on Small Language Model (SLM) according to an embodiment of the present invention is disclosed. The hub device may include a first communication module for short-range wireless communication with the personal devices, a second communication module for communication with an external server, and a memory. The hub device may receive, through the first communication module, first information processed by a first SLM of a first personal device of a first information provider, from the first personal device. The first information may include at least one of first basic information identified based on data of the first personal device, first processed information generated by processing the first basic information, first license information set to restrict the use of the first basic information and the first processed information, or first personal information about characteristics of the first information provider. The hub device may receive, through the first communication module, second information processed by a second SLM of a second personal device of a second information provider, from the second personal device. The second information may include at least one of second basic information identified based on data of the second personal device, second processed information generated by processing the second basic information, second license information set to restrict the use of the second basic information and the second processed information, or second personal information about characteristics of the second information provider.

Furthermore, according to an embodiment of the present invention, the hub device may receive, through the second communication module, a search request including information about an information search scope specified by an information requester from the external server. The information search scope may include at least one of the type of information to be used, scope of use, authority, usage conditions, required frequency, usage period, quality, redistribution rights, redistribution scope, exclusive ownership status, billing policy, payment method, or information about characteristics of the information provider.

Furthermore, according to an embodiment of the present invention, the hub device may check whether information matching the information search scope exists among a plurality of information including the first information and the second information. Based on identifying information matching the information search scope among the plurality of information including the first information and the second information, the hub device may transmit, to the external server, data requesting the information requester to pay a fee according to the billing policy and payment method identified by the information matching the information search scope, and a list including the information matching the information search scope. Based on receiving payment information indicating that payment of the fee for the information selected from the list by the information requester is completed, the hub device may provide the selected information to the external server. The selected information may include information corresponding to one information provider or information corresponding to multiple information providers.

Furthermore, according to an embodiment of the present invention, the hub device may transmit a message indicating that the selected information has been provided to the external server, to the personal device of the information provider who provided the selected information.

Furthermore, according to an embodiment of the present invention, the first information may include the first basic information, which is identified through internal data stored in the first personal device and data obtained through a first sensor of the first personal device, and processed by the first SLM of the first personal device. The first information may include the first processed information generated by processing the first basic information by the first SLM of the first personal device. The first information may include first metadata regarding at least one of the type, quality, acquisition time, acquisition period, or acquisition location of the first basic information, and at least one of the type, quality, processing method, or processing degree of the first processed information. The first information may include the first license information regarding at least one of the scope of use, authority, usage conditions, redistribution rights, redistribution scope, usage period, expiration period, exclusive ownership status, billing policy, or payment method for the first basic information and the first processed information, set by the first information provider. The first information may include the first personal information about characteristics of the first information provider, including at least one of gender, age, nationality, residence, health status, medical history, prescription records, marital status, family information, SNS accounts, login information, online activity records, educational background, grades, school records, scholarship information, occupation, position, career, income, company location, owned vehicle information, loan history, credit card usage history, tax payment history, hobbies, interests, purchase history, consumption patterns, religion, race, criminal record, or legal dispute details. The first information may include first device information including a first identifier assigned to the first personal device to distinguish the first personal device from other devices. The hub device may determine, based on the first information matching the information search scope, that the first information is providable information to the external server.

Furthermore, according to an embodiment of the present invention, based on not identifying information matching the information search scope among the plurality of information including the first information and the second information, the hub device may select a device matching the information search scope from among devices including the first personal device and the second personal device, request the selected device to provide additional information corresponding to the information search scope, obtain the additional information from the selected device, and based on the additional information matching the information search scope, provide the additional information to the external server.

Furthermore, according to an embodiment of the present invention, the first processed information may include 1-1 processed information and 1-2 processed information. The hub device may, based on the metadata, identify a first processing degree indicating the processing degree of the 1-1 processed information and a second processing degree indicating the processing degree of the 1-2 processed information. Based on the license information, the hub device may identify first price information indicating the price set for the 1-1 processed information, second price information indicating the price set for the 1-2 processed information, and third price information indicating the price set for the basic information. Upon selection of the first information from the list by the information requester, the hub device may check the payment information for the first information. Based on the paid fee confirmed by the payment information corresponding to the first price information, the hub device may provide the 1-1 processed information to the external server. Based on the paid fee confirmed by the payment information corresponding to the second price information, the hub device may provide the 1-2 processed information to the external server. Based on the paid fee confirmed by the payment information corresponding to the third price information, the hub device may provide the basic information to the external server.

Furthermore, according to an embodiment of the present invention, the first personal device may include a 1-1 personal device, a 1-2 personal device, and a 1-3 personal device. The first information may include 1-1 information provided from the 1-1 personal device, 1-2 information provided from the 1-2 personal device, and 1-3 information provided from the 1-3 personal device. The hub device may request time synchronization to the 1-1 personal device, the 1-2 personal device, and the 1-3 personal device. Through the microphone of the hub device, based on the utterance of the first information provider requesting information provision, the hub device may obtain first utterance information. By processing the sentence included in the first utterance information with the LLM, the hub device may generate a plurality of requests composed in natural language. By analyzing the characteristics of the plurality of requests composed in natural language, the hub device may identify the devices to which the plurality of requests will be provided. Based on the characteristics of the plurality of requests, the hub device may transmit a first request to the 1-1 personal device, transmit a second request to the 1-2 personal device, and transmit a third request to the 1-3 personal device. The hub device may receive the 1-1 information processed by the 1-1 SLM of the 1-1 personal device based on the first request composed in natural language and to which time synchronization is applied by the 1-1 personal device, the 1-2 information processed by the 1-2 SLM of the 1-2 personal device based on the second request composed in natural language and to which time synchronization is applied by the 1-2 personal device, and the 1-3 information processed by the 1-3 SLM of the 1-3 personal device based on the third request composed in natural language and to which time synchronization is applied by the 1-3 personal device. The hub device may store the received 1-1 information, 1-2 information, 1-3 information, and information about the synchronized time in the memory. Based on the information about the synchronized time, the hub device may merge the 1-1 information, the 1-2 information, and the 1-3 information. Using the merged information, the hub device may perform inference through the LLM. The hub device may store the answer information generated by the inference in the memory. The hub device may output the voice corresponding to the answer information through the speaker of the hub device or display the screen corresponding to the answer information through the display of the hub device.

Furthermore, according to an embodiment of the present invention, the 1-1 device may be a refrigerator, the 1-2 device may be an oven, and the 1-3 device may be a bidet. Based on the utterance of the first information provider requesting a recommendation for food to cook, the hub device may obtain the first utterance information. By processing the sentence included in the first utterance information with the LLM, the hub device may generate the first request requesting information about ingredients in the refrigerator, the second request requesting information about dishes cooked in the oven, and the third request requesting information about the bowel condition of the first information provider. Based on the 1-1 information, the 1-2 information, and the 1-3 information obtained based on the first request, the second request, and the third request, the hub device may determine the dish to recommend to the first information provider. The hub device may store the answer information about the recommended dish in the memory. The hub device may output the voice corresponding to the answer information through the speaker of the hub device or display the screen corresponding to the answer information through the display of the hub device.

Furthermore, according to an embodiment of the present invention, the hub device may store first merged information by matching the first information related to the first information provider and the answer information. Among the information including the first merged information where the first information and the answer information are matched, the hub device may determine information matching the information search scope requested by the information requester as information providable to the external server.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating devices included in a network according to various embodiments of the present invention.

FIG. 2 is a diagram illustrating a system for providing information according to a protection policy of an information provider using a personal AI device including an SLM and a hub AI device including an LLM, according to various embodiments of the present invention.

FIG. 3 is a block diagram of devices according to various embodiments of the present invention.

FIG. 4 is a diagram illustrating a method of providing information of an information provider to an information requester according to various embodiments of the present invention.

FIG. 5 is a diagram illustrating the content of information according to various embodiments of the present invention.

FIG. 6 is a diagram illustrating a method of providing processed information corresponding to a paid price according to various embodiments of the present invention.

FIG. 7 is a diagram illustrating a plurality of personal devices related to one information provider according to various embodiments of the present invention.

FIG. 8 is a diagram illustrating time synchronization according to various embodiments of the present invention.

FIG. 9 is a diagram illustrating a method of outputting answer information using a plurality of personal devices upon request from an information provider to provide an AI personalization service, according to various embodiments of the present invention.

### DETAILED DESCRIPTION OF EXEMPLARY EMBODIMENTS

The present invention is capable of various modifications and may have various embodiments, and specific embodiments are illustrated in the drawings and will be described in detail. In describing the present invention, if it is determined that a detailed description of related known technologies may unnecessarily obscure the gist of the present invention, the detailed description thereof will be omitted. Hereinafter, various embodiments of the present document are described with reference to the accompanying drawings. The embodiments and terms used therein are not intended to limit the technology described in this document to specific embodiments, and should be understood to include various changes, equivalents, and/or substitutes thereof. Regarding the description of the drawings, similar reference numerals may be used for similar components. Singular expressions may include plural expressions unless the context clearly indicates otherwise. In this document, expressions such as “A or B” or “at least one of A and/or B” may include all possible combinations of the items listed together. Expressions such as “first,” “second,” “primary,” or “secondary” may modify the corresponding components regardless of order or importance, and are used only to distinguish one component from another and do not limit the corresponding components. When a certain (e.g., first) component is referred to as being “(functionally or communicatively) connected” or “coupled” to another (e.g., second) component, the certain component may be directly connected to the other component, or may be connected through another component (e.g., a third component).

In this document, “configured (or set) to” may, depending on the situation, be used interchangeably with, for example, “suitable for,” “having the capability to,” “modified to,” “made to,” “capable of,” or “designed to” in hardware or software. In some situations, the expression “device configured to” may mean that the device is “capable of” doing something together with other devices or components. For example, the phrase “processor configured (or set) to perform A, B, and C” may mean a dedicated processor (e.g., an embedded processor) for performing the corresponding operations, or a general-purpose processor (e.g., CPU or application processor) capable of performing the corresponding operations by executing one or more software programs stored in a memory device.

An electronic device according to various embodiments of this document may include, for example, at least one of a smartphone, tablet PC, mobile phone, video phone, e-book reader, desktop PC, laptop PC, netbook computer, workstation, server, smart mirror, PDA, portable multimedia player (PMP), MP3 player, medical device, camera, or wearable device. A wearable device may include at least one of an accessory type (e.g., watch, ring, bracelet, anklet, necklace, glasses, contact lens, or head-mounted-device (HMD)), fabric or clothing integrated type (e.g., electronic clothing), body-attached type (e.g., skin pad or tattoo), or bio-implantable circuit. In some embodiments, the electronic device may include, for example, at least one of a television, digital video disk (DVD) player, audio system, refrigerator, air conditioner, cleaner, oven, microwave oven, washing machine, air purifier, set-top box, home automation control panel, security control panel, media box (e.g., Samsung HomeSync™, Apple TV™, or Google TV™), game console (e.g., Xbox™, PlayStation™), electronic dictionary, electronic key, camcorder, or electronic frame.

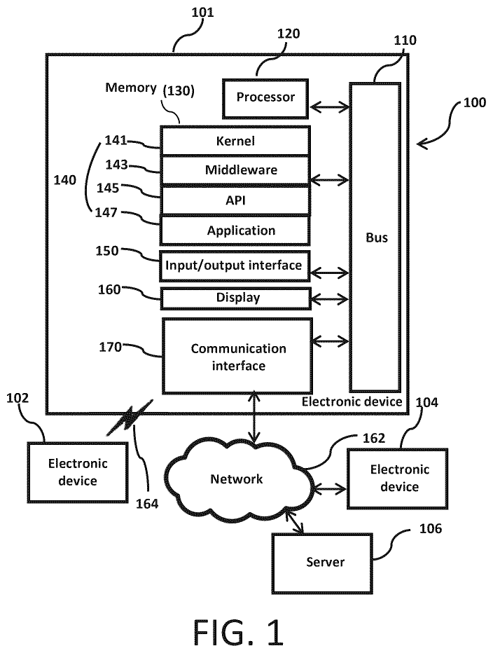

FIG. 1 is a diagram illustrating devices included in a network according to various embodiments of the present invention. An electronic device 101 may include a bus 110, a processor 120, a memory 130, an input/output interface 150, a display 160, and a communication interface 170. In some embodiments, the electronic device 101 may omit at least one of the components or additionally include other components. The bus 110 may include circuitry that connects the components 110-170 to each other and transfers communication (e.g., control messages or data) between the components. The processor 120 may include one or more of a central processing unit, an application processor, or a communication processor (CP). The processor 120 may, for example, perform operations or data processing related to control and/or communication of at least one other component of the electronic device 101. The memory 130 may include volatile and/or non-volatile memory. The memory 130 may, for example, store instructions or data related to at least one other component of the electronic device 101. According to one embodiment, the memory 130 may store software and/or a program 140. The program 140 may include, for example, a kernel 141, middleware 143, an application programming interface (API) 145, and/or application programs (or “applications”) 147. At least some of the kernel 141, middleware 143, or API 145 may be referred to as an operating system.

The kernel 141 may, for example, control or manage system resources (e.g., bus 110, processor 120, or memory 130) used to execute operations or functions implemented in other programs (e.g., middleware 143, API 145, or application programs 147). Also, the kernel 141 may provide an interface through which middleware 143, API 145, or application programs 147 can access individual components of the electronic device 101 to control or manage system resources. Middleware 143 may, for example, play an intermediary role so that API 145 or application programs 147 can communicate with the kernel 141 to exchange data. Also, middleware 143 may process one or more task requests received from application programs 147 according to priority. For example, middleware 143 may grant priority for using system resources of the electronic device 101 (e.g., bus 110, processor 120, or memory 130) to at least one of the application programs 147 and process the one or more task requests. The API 145 is an interface for applications 147 to control functions provided by the kernel 141 or middleware 143, and may include, for example, at least one interface or function (e.g., instruction) for file control, window control, image processing, or character control. The input/output interface 150 may, for example, transfer instructions or data input from a user or another external device to other component(s) of the electronic device 101, or output instructions or data received from other component(s) of the electronic device 101 to the user or another external device.

The display 160 may include, for example, a liquid crystal display (LCD), a light emitting diode (LED) display, an organic light emitting diode (OLED) display, a micro electro mechanical system (MEMS) display, or an electronic paper display. The display 160 may, for example, display various contents (e.g., text, images, videos, icons, and/or symbols) to the user. The display 160 may include a touch screen and may receive, for example, a touch, gesture, proximity, or hovering input using an electronic pen or a part of the user's body. The communication interface 170 may, for example, establish communication between the electronic device 101 and an external device (e.g., a first external electronic device 102, a second external electronic device 104, or a server 106). For example, the communication interface 170 may connect to a network 162 through wireless communication or wired communication to communicate with an external device (e.g., the second external electronic device 104 or the server 106).

Wireless communication may include, for example, cellular communication using at least one of LTE, LTE-A (LTE Advance), CDMA (code division multiple access), WCDMA (wideband CDMA), UMTS (universal mobile telecommunications system), WiBro (Wireless Broadband), or GSM (Global System for Mobile Communications). According to one embodiment, wireless communication may include, for example, at least one of WiFi (wireless fidelity), Bluetooth, Bluetooth Low Energy (BLE), Zigbee, NFC (near field communication), Magnetic Secure Transmission, radio frequency (RF), or Body Area Network (BAN). According to one embodiment, wireless communication may include GNSS. GNSS may be, for example, GPS (Global Positioning System), Glonass (Global Navigation Satellite System), Beidou Navigation Satellite System (hereinafter “Beidou”), or Galileo, the European global satellite-based navigation system. Hereinafter, in this document, “GPS” may be used interchangeably with “GNSS”. Wired communication may include, for example, at least one of USB (universal serial bus), HDMI (high definition multimedia interface), RS-232 (recommended standard 232), power line communication, or POTS (plain old telephone service). The network 162 may include a telecommunications network, for example, at least one of a computer network (e.g., LAN or WAN), the Internet, or a telephone network.

Each of the first and second external electronic devices 102, 104 may be a device of the same or different type as the electronic device 101. According to various embodiments, all or part of the operations performed in the electronic device 101 may be performed in another one or more electronic devices (e.g., electronic devices 102, 104, or server 106). According to one embodiment, if the electronic device 101 needs to perform a certain function or service automatically or upon request, the electronic device 101 may request another device (e.g., electronic devices 102, 104, or server 106) to perform at least some functions related thereto, instead of or in addition to performing the function or service itself. The other electronic device (e.g., electronic devices 102, 104, or server 106) may execute the requested function or additional functions and deliver the result to the electronic device 101. The electronic device 101 may provide the requested function or service by processing the received result as is or additionally. For this purpose, for example, cloud computing, distributed computing, or client-server computing technology may be used.

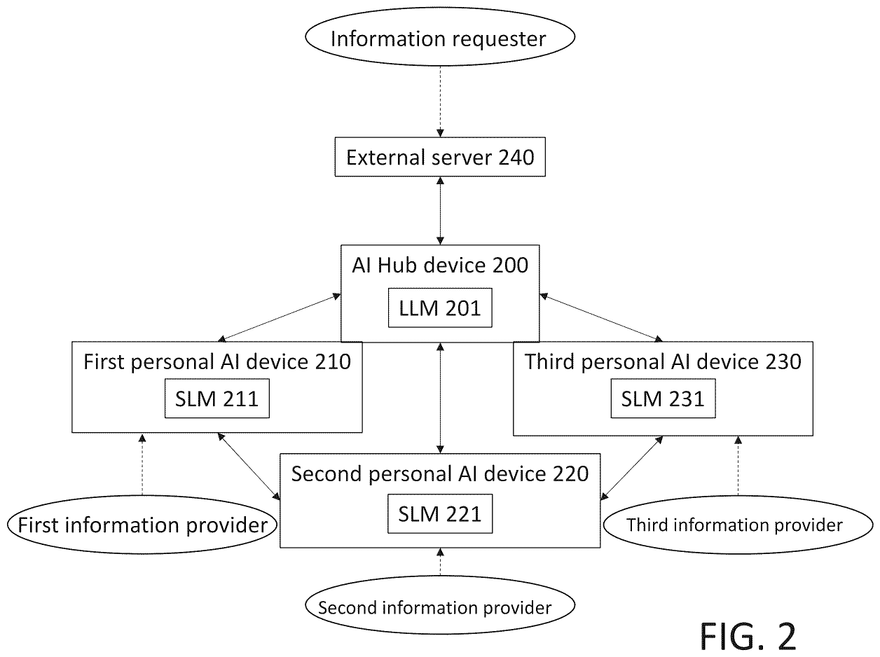

FIG. 2 is a diagram illustrating a system for providing information according to a protection policy of an information provider using a personal AI device including an SLM and a hub AI device including an LLM, according to various embodiments of the present invention. According to one embodiment, the hub device 200 (e.g., AI hub device) of FIG. 2 may be the electronic device 101 of FIG. 1. The first personal device 210 (e.g., first personal AI device) of FIG. 2 may be the electronic device 102 or electronic device 104 of FIG. 1. The second personal device 220 (e.g., second personal AI device) of FIG. 2 may be the electronic device 102 or electronic device 104 of FIG. 1. The third personal device 230 (e.g., third personal AI device) of FIG. 2 may be the electronic device 102 or electronic device 104 of FIG. 1. The external server 240 of FIG. 2 may be the server 106 of FIG. 1. The hub device 200 may communicate with a plurality of personal devices (e.g., 210, 220, 230), and the number of personal devices (e.g., 210, 220, 230) is not limited. The plurality of personal devices (e.g., 210, 220, 230) may be implemented as IoT devices located in a house, but are not limited thereto. The plurality of personal devices (e.g., 210, 220, 230) may also communicate with each other. The hub device 200 may be understood as a home server communicating with IoT devices, but is not limited thereto. The hub device 200 may communicate with the external server 240, and the external server 240 may also be understood as an external device. According to various embodiments, the external server 240 may be a server providing a platform for bidding on data to users and companies that need data, but is not limited thereto.

Referring to FIG. 2, a hub device 200 according to an embodiment of the present invention may include a Large Language Model (LLM) 201. A first personal device 210 may include a Small Language Model (SLM) 211. A second personal device 220 may include an SLM 221. A third personal device 230 may include an SLM 231. An SLM may include a smaller Large Language Model (sLLM). A first information provider may own the first personal device 210. Alternatively, the first information provider may use the first personal device 210. A second information provider may own the second personal device 220. Alternatively, the second information provider may use the second personal device 220. A third information provider may own the third personal device 230. Alternatively, the third information provider may use the third personal device 230. The external server 240 may, upon request from an information requester, request the hub device 200 for at least one of the first information of the first personal device 210, the second information of the second personal device 220, or the third information of the third personal device 230. The method of providing information of the information provider according to the request of the information requester will be described later.

According to various embodiments, an artificial intelligence analysis model (e.g., LLM or SLM) can be trained using training data. As a training process for the AI analysis model, a result value (output data) is obtained using the AI analysis model assigned with arbitrary weights, the obtained result value is compared with labeled data of the training data, and backpropagation is performed according to the error, thereby optimizing the weights. Specifically, training the AI analysis model means a process of training the AI analysis model based on training data and labeled data or unlabeled data, so that the AI analysis model can determine output data for input data. That is, the AI analysis model forms rules for the data and makes judgments. Training an AI analysis model may mean adjusting the weights the model has. According to one embodiment, various methods such as supervised learning, unsupervised learning, reinforcement learning, imitation learning, federated-learning, etc., can be used as the training method.

According to various embodiments, the AI analysis model (e.g., LLM or SLM) may include a convolutional neural network (CNN). As the CNN structure, at least one of AlexNet, LENET, NIN, VGGNet, ResNet, WideResnet, GoogleNet, FractaNet, DenseNet, FitNet, RitResNet, HighwayNet, MobileNet, DeeplySupervisedNet may be used. According to one embodiment, the AI analysis model may be implemented using multiple CNN structures. For example, the AI analysis model may use both 1D CNN and 2D CNN, and may be implemented using either a GRU neural network or an LSTM neural network. In one embodiment, the 1D CNN and 2D CNN may include a block in which a CNN layer having multiple filters of a specific size, a ReLu layer, a pooling layer, and a dropout layer are sequentially combined for feature extraction, and may include an FC (fully connected) layer and an activation layer (e.g., sigmoid, softmax, etc.). According to one embodiment, a convolution layer can extract features from input data. Also, the convolution layer may consist of a filter that extracts features and an activation function that converts the value of the feature-extracting filter into a non-linear value. The filter may include a function that detects whether the feature is included in the input data.

According to various embodiments, various algorithms (e.g., machine learning algorithms) and/or Model for providing services may be used in addition to the AI analysis model.

According to various embodiments, the AI analysis model (e.g., LLM or SLM) may be implemented including a classifier and/or a regression model. The classifier can perform binary classification or multi-class classification. The AI analysis model may be a multi-class classification model that classifies input data into more specific classes. In one embodiment, the classifier may use various types of algorithms such as decision tree, support vector machine, random forest, etc. This is just an example and is not limited thereto.

According to various embodiments, the AI analysis model (e.g., LLM or SLM) may be implemented in the form of a regression model that generates auxiliary information of an emotional state. The regression model may use types of algorithms such as linear regression, regression tree, support vector regression, kernel regression, etc. This is just an example and is not limited thereto.

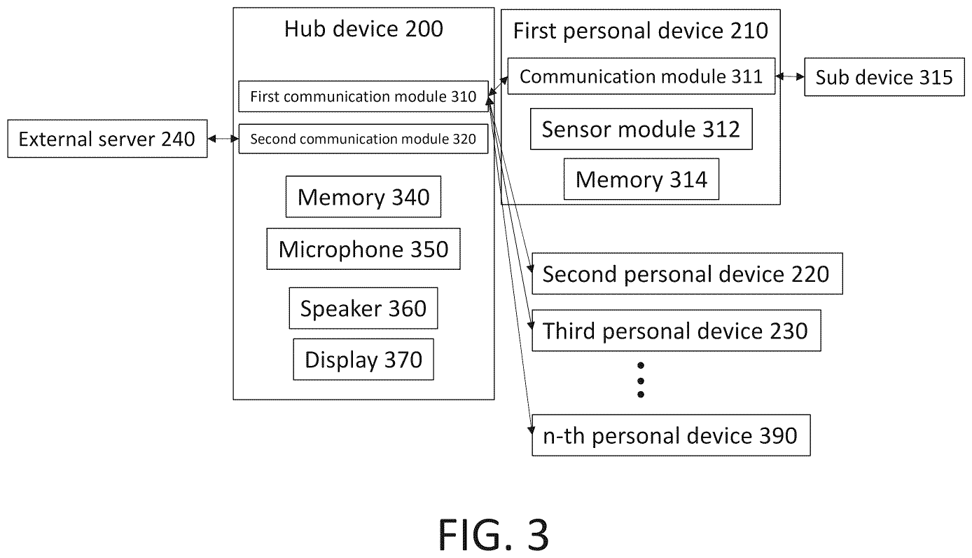

FIG. 3 is a block diagram of devices according to various embodiments of the present invention. Referring to FIG. 3, a hub device 200 according to various embodiments of the present invention may include at least one of a first communication module 310, a second communication module 320, a memory 340, a microphone 350, a speaker 360, or a display 370. According to one embodiment, the hub device 200 may communicate with personal devices (e.g., 210, 220, 230, 390) through the first communication module 310. The first communication module 310 may include a communication circuit supporting a short-range wireless communication method. According to one embodiment, the hub device 200 may communicate with the external server 240 through the second communication module 320. There is no restriction on the communication method supported by the second communication module 320.

Referring to FIG. 3, a personal device (e.g., 210, 220, 230, 390) according to various embodiments of the present invention may include a communication module (e.g., 311), a sensor module (e.g., 312), and a memory (e.g., 314). For example, the first personal device 210 may perform short-range wireless communication with the hub device 200 through the communication module 311. For example, the first personal device 210 may communicate with a sub-device 315 through the communication module 311. For example, the first personal device 210 may acquire data through the sensor module 312. There is no restriction on the number of sensors included in the sensor module 312. For example, the first personal device 210 may store data acquired through a plurality of sensors (or a single sensor) included in the sensor module 312 in the memory 314. For example, the first personal device 210 may store data acquired based on the characteristics of the first personal device 210 (e.g., information about ingredients in the refrigerator if the first personal device 210 is a refrigerator) in the memory 314.

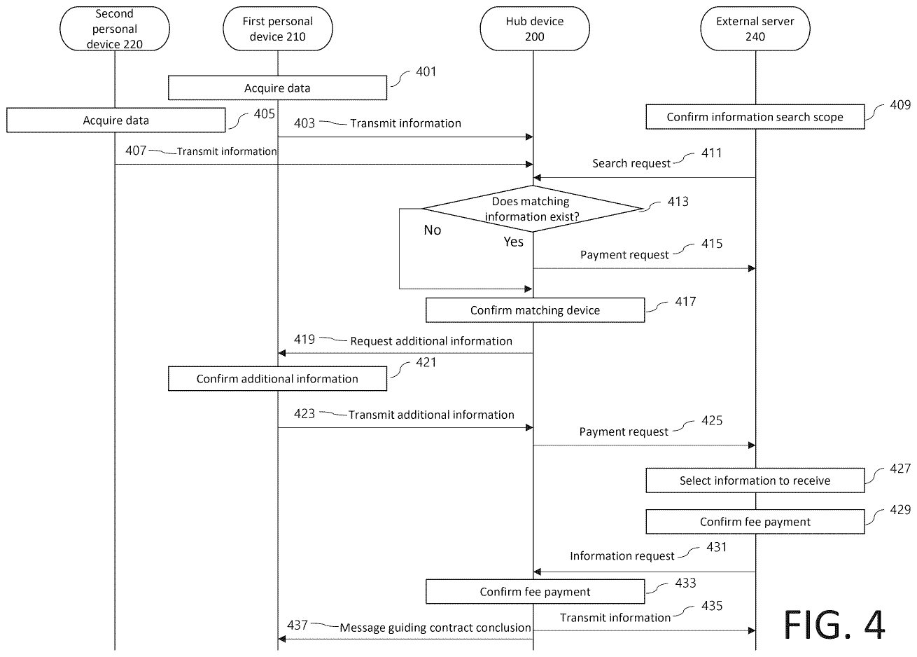

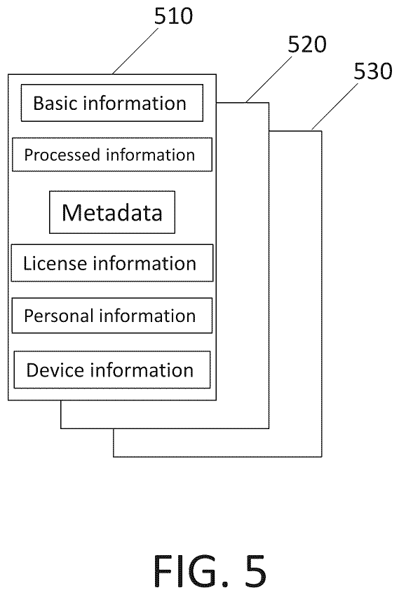

FIG. 4 is a diagram illustrating a method of providing information of an information provider to an information requester according to various embodiments of the present invention. FIG. 5 is a diagram illustrating the content of information according to various embodiments of the present invention.

Referring to FIG. 4, the hub device 200 may obtain information from a plurality of personal devices (e.g., 210, 220). The hub device 200 may provide information corresponding to a plurality of information providers (e.g., information of FIG. 5) to the external server 240 according to a request from an information requester received through the external server 240. Specific operations will be described with reference to FIG. 4. The operations of FIG. 4 are described using the first personal device 210 as an example, but the operations of other personal devices (e.g., 220, 230, 390) can also be explained by the operations of FIG. 4.

In operation 401, according to various embodiments, the first personal device 210 may acquire data. The first personal device 210 may acquire data based on the characteristics of the first personal device 210. For example, if the first personal device 210 is a refrigerator, it may acquire information about ingredients in the refrigerator. For example, if the first personal device 210 is an oven, it may acquire information about dishes cooked in the oven. The first personal device 210 may acquire sensing data through the sensor module 312. For example, if the first personal device 210 is a bidet including a camera as the sensor module 312, it may acquire data about the user's bowel condition confirmed through the camera. The first personal device 210 may acquire data input by the information provider (e.g., the first information provider) using the first personal device 210. The data input by the information provider (e.g., the first information provider) is not limited to personal information and setting information, and the types of data input by the information provider (e.g., the first information provider) can be understood through the embodiments described later. The first personal device 210 may generate information based on the acquired data.

In operation 403, according to various embodiments, the first personal device 210 may transmit information (e.g., first information) to the hub device 200. The information transmitted in operation 403 may be information generated based on the data from operation 401. For example, the first personal device 210 may generate the first information of the first personal device 210 by processing the data acquired in operation 401 using the SLM 211. Referring to FIG. 5, the first information may include at least one of basic information, processed information, metadata, license information, personal information, or device information. The first personal device 210 may transmit the first information including at least one of basic information, processed information, metadata, license information, personal information, or device information to the hub device 200. The hub device 200 may store the first information provided from the first personal device 210 in the memory 340.

The first information of operation 403 may include first basic information identified through internal data stored in the first personal device 210 and data acquired through the first sensor of the first personal device 210, and processed by the first SLM 211 of the first personal device 210. For example, the first personal device 210 may be a bidet, refrigerator, oven, TV, washing machine, bed, lighting device, or smartphone, and the type of the first personal device 210 is not limited. For example, the basic information may include data about the current location. For example, the basic information may include data about bowel movement photos collected from the bidet. For example, the basic information may include photo data of ingredients in the refrigerator. For example, the basic information may include information about dishes cooked in the oven. For example, the basic information may include TV viewing history. For example, the basic information may include data about photos of laundry washed in the washing machine. For example, the basic information may include sleep time data acquired through sensors in the bed. For example, the basic information may include data about the time the lighting device was controlled to be on. For example, the basic information may include data about the usage history of the smartphone.

The first information of operation 403 may include first processed information generated by processing the first basic information by the first SLM 211 of the first personal device 210. Processed information may be information abstracted or transformed from the basic information according to the degree of processing. The first personal device 210 may check the processing degree set by the first information provider and process the first basic information into the first processed information based on the identified processing degree. For example, the processed information may include data abstracted to a level of a specified distance (e.g., several meters to several kilometers) according to the processing degree for data about the current location. For example, the processed information may include data generated by correcting the image quality (e.g., first level processed data) or converting the photo into corresponding text (e.g., “diarrhea”) (e.g., second level processed data) according to the processing degree for data about bowel movement photos. For example, the processed information may include data generated by correcting the image quality (e.g., first level processed data), converting into corresponding icons (e.g., second level processed data), or converting into corresponding text (e.g., “apple”) (e.g., third level processed data) according to the processing degree for photo data of ingredients. For example, the processed information may include data abstracted or transformed according to the processing degree for information about dishes cooked in the oven. For example, the processed information may include at least some data among data including the type of viewed video, title of viewed video, characteristics of content included in the viewed video, viewing time, and viewing duration, according to the processing degree for TV viewing history. For example, the processed information may include data abstracted or transformed according to the processing degree for data about photos of laundry. For example, the processed information may include data abstracted or transformed according to the processing degree for sleep time data. For example, the processed information may include data abstracted or transformed according to the processing degree for data about the time the lighting device was controlled to be on. For example, the processed information may include data abstracted or transformed according to the processing degree for data about the usage history of the smartphone.

The first information of operation 403 may include first metadata about at least one of the type, quality, acquisition time, acquisition period, or acquisition location of the first basic information, and at least one of the type, quality (e.g., for photos, resolution, image quality, surrounding environment information including illumination and temperature at the time the photo was acquired), processing method (e.g., post-processing method), or processing degree of the first processed information. The first personal device 210 may generate the first metadata about at least one of the type, quality, acquisition time, acquisition period, or acquisition location of the first basic information, and at least one of the type, quality, processing method, or processing degree of the first processed information.

The first information of operation 403 may include first license information about at least one of the usage scope, rights, usage conditions, redistribution rights, redistribution scope, usage period, expiration period, exclusive ownership status, billing policy, or payment method for the first basic information and the first processed information set by the first information provider. The first license information may be information that determines the scope of utilization of the first information. By setting the first license information through the first personal device 210, the first information provider can establish a contract with the information requester later without separate intervention, and billing or settlement can be performed based on the contract. The contract may be established immediately upon the information requester's request, or may be established after one information requester selected through an auction process among multiple information requesters pays the auction price, and there is no restriction on how the contract is established.

The first information of operation 403 may include first personal information about the characteristics of the first information provider, including at least one of gender, age, nationality, residence, health status, medical history, prescription record, marital status, family information, SNS account, login information, online activity record, education, grades, school life record, scholarship information, occupation, position, career, income, company location, owned vehicle information, loan history, credit card usage history, tax payment history, hobbies, interests, purchase history, consumption pattern, religion, race, criminal record, or legal dispute history. The first personal device 210 may generate the first personal information about the characteristics of the first information provider based on the input of the first information provider. The first personal device 210 may process the first personal information according to the processing degree, and in this case, the first processed information may include not only processed information of the first basic information but also processed information of the first personal information.

The first information of operation 403 may include first device information including a first identifier assigned to the first personal device 210 to distinguish it from other devices.

In operation 405, according to various embodiments, the second personal device 220 may acquire data. Operation 405 can be explained by operation 401.

In operation 407, according to various embodiments, the second personal device 220 may transmit information (e.g., second information) to the hub device 200. The information transmitted in operation 407 may be information generated based on the data from operation 405. For example, the second personal device 220 may generate the second information of the second personal device 220 by processing the data acquired in operation 405 using the SLM 221. Referring to FIG. 5, the second information may include at least one of basic information, processed information, metadata, license information, personal information, or device information. The second personal device 220 may transmit the second information including at least one of basic information, processed information, metadata, license information, personal information, or device information to the hub device 200. The hub device 200 may store the second information provided from the second personal device 220 in the memory 340. The hub device 200 may receive multiple pieces of information (e.g., the first information 510 from the first personal device 210, the second information 520 from the second personal device 220, and information 530 from other personal devices) from multiple personal devices (e.g., 210, 220, 230, 390) and generate a list including the received information. At least part of the generated list may be provided to the external server 240 later.

In operation 409, according to various embodiments, the external server 240 may identify the information search scope. The external server 240 may identify the information search scope according to the request of the information requester. The information requester may set the information search scope. The information search scope may include at least one of the type of information to be used, scope of use, authority, usage conditions, required frequency, usage period, quality, redistribution rights, redistribution scope, exclusive ownership status, billing policy, payment method, or information about the characteristics of the information provider. By setting the information search scope, the information requester can obtain filtered information.

In operation 411, according to various embodiments, the hub device 200 may receive a search request including information about the information search scope specified by the information requester from the external server 240.

In operation 413, according to various embodiments, the hub device 200 may check whether information matching the information search scope of operation 411 exists among the plurality of information including the first information of operation 403 and the second information of operation 407. Operation 413 can be understood as a filtering operation. The hub device 200 may search for information matching the information search scope to provide filtered information to the information requester.

In operation 415, according to various embodiments, based on identifying information matching the information search scope among the plurality of information including the first information and the second information, the hub device 200 may transmit a payment request to the external server 240. For example, based on the first information provided from the first personal device 210 in operation 403 matching the information search scope, the hub device 200 may determine the first information as information providable to the external server 240. For example, the hub device 200 may transmit a payment request including data requesting the information requester to pay a fee according to the billing policy and payment method identified by the information matching the information search scope, to the external server 240. For example, the hub device 200 may transmit a payment request including a list containing the information matching the information search scope to the external server 415.

In operation 417, according to various embodiments, based on not identifying information matching the information search scope among the plurality of information including the first information and the second information, the hub device 200 may identify a device matching the information search scope among devices including the first personal device 210 and the second personal device 220. For example, the hub device 200 may select the first personal device 210 that matches the information search scope.

In operation 419, according to various embodiments, the hub device 200 may request the device selected in operation 417 (e.g., the first personal device 210) to provide additional information corresponding to the information search scope. In operation 421, the first personal device 210 may identify the additional information corresponding to the information search scope. In operation 423, the first personal device 210 may transmit the additional information to the hub device 200. The additional information may be information similar to the first information of operation 403 and match the information search scope. Through operations 417, 419, 421, and 423, the hub device 200 can obtain the information requested by the information requester by receiving additional information from the personal device(s) when the requested information is not yet stored in the hub device 200.

In operation 425, according to various embodiments, based on the obtained additional information matching the information search scope, the hub device 200 may transmit a payment request to the external server 240. Operation 425 can be explained by operation 415.

In operation 427, according to various embodiments, based on the payment request (e.g., operation 415 or 425), the external server 240 may select the information to be received according to the selection of the information requester. The external server 240 may provide the information requester with a list including the information matching the information search scope and information about the amount to be paid to receive at least one piece of information included in the list, and select the information to be received according to the selection of the information requester.

In operation 429, according to various embodiments, the external server 240 may confirm the fee payment. For example, the external server 240 may obtain payment information proving that the information requester has paid the amount corresponding to the information selected in operation 427.

In operation 431, according to various embodiments, the hub device 200 may receive an information request from the external server 240. The external device 240 may provide the payment information of operation 429 to the hub device 200 and request the provision of information to the external server 240.

In operation 433, according to various embodiments, based on receiving the payment information indicating that the payment for the information selected from the list by the information requester is completed, the hub device 200 may confirm the completion of the fee payment.

In operation 435, according to various embodiments, based on receiving the payment information indicating that the payment for the information selected from the list by the information requester is completed, the hub device 200 may provide the information selected in operation 427 to the external server 240. The information selected in operation 427 may include information corresponding to one information provider or information corresponding to multiple information providers.

In operation 437, according to various embodiments, the hub device 200 may transmit a message indicating that the information selected in operation 427 has been provided to the external server 240, to the personal device (e.g., the first personal device 210) of the information provider who provided the selected information.

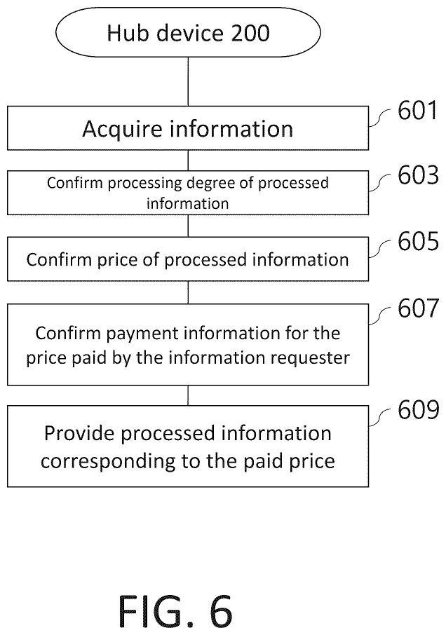

FIG. 6 is a diagram illustrating a method of providing processed information corresponding to a paid price according to various embodiments of the present invention.

In operation 601, according to various embodiments, the hub device 200 may obtain information based on operations 403 and 407 of FIG. 4. The obtained information may include processed information.

In operation 603, according to various embodiments, the hub device 200 may identify the processed information in the obtained information and check the processing degree of the processed information. For example, the first information provided from the first personal device 210 may include first basic information, first processed information, first metadata, first license information, first personal information, and first device information. The first processed information of the first personal device 210 may include at least one piece of processed information. For example, the first processed information may include 1-1 processed information and 1-2 processed information. The 1-1 processed information may be information processed from the first basic information and/or the first personal information based on a first processing degree. The 1-2 processed information may be information processed from the first basic information and/or the first personal information based on a second processing degree. For example, the hub device 200 may, based on the metadata, identify the first processing degree indicating the processing degree of the 1-1 processed information and the second processing degree indicating the processing degree of the 1-2 processed information.

In operation 605, according to various embodiments, the hub device 200 may check the price of the processed information. For example, the information provider may set different prices for the basic information and the processed information based on the processing degree, and/or set different prices for different pieces of processed information. For example, the hub device 200 may, based on the license information, identify first price information indicating the price set for the 1-1 processed information, second price information indicating the price set for the 1-2 processed information, and third price information indicating the price set for the basic information. According to various embodiments, the hub device 200 may provide the information about the processing degree identified in operation 603 and the price information identified in operation 605 to the external server 240, so that the information requester can select information of an appropriate price. For example, when performing operation 415 or 425 of FIG. 4, the hub device 200 may provide the information about the processing degree identified in operation 603 and the price information identified in operation 605 to the external server 240.

In operation 607, according to various embodiments, based on operation 431 of FIG. 4, the hub device 200 may check the payment information for the price paid by the information requester. For example, upon selection of the first information of the first personal device 210 from the list provided to the information requester, the hub device 200 may check the payment information for the first information.

In operation 609, according to various embodiments, the hub device 200 may provide the processed information (or basic information) corresponding to the paid price to the external server 240. For example, based on the paid fee confirmed by the payment information corresponding to the first price information, the hub device 200 may provide the 1-1 processed information to the external server 240. Based on the paid fee confirmed by the payment information corresponding to the second price information, the hub device 200 may provide the 1-2 processed information to the external server 240. Based on the paid fee confirmed by the payment information corresponding to the third price information, the hub device 200 may provide the basic information to the external server 240.

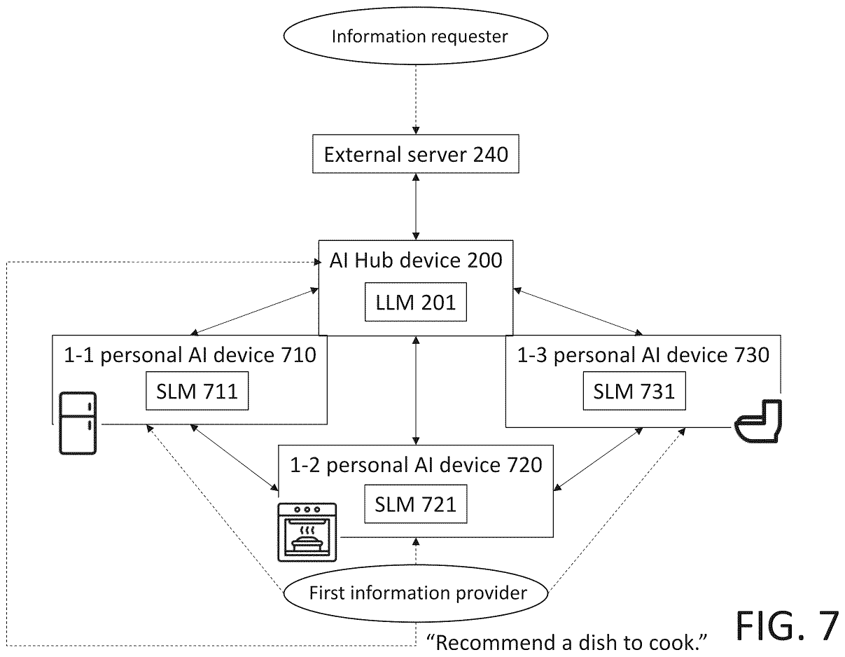

FIG. 7 is a diagram illustrating a plurality of personal devices related to one information provider according to various embodiments of the present invention. According to one embodiment, the hub device 200 (e.g., AI hub device) of FIG. 7 may be the electronic device 101 of FIG. 1. The 1-1 personal device 710 (e.g., 1-1 personal AI device) of FIG. 7 may be the electronic device 102 or electronic device 104 of FIG. 1. The 1-2 personal device 720 (e.g., 1-2 personal AI device) of FIG. 7 may be the electronic device 102 or electronic device 104 of FIG. 1. The 1-3 personal device 730 (e.g., 1-3 personal AI device) of FIG. 7 may be the electronic device 102 or electronic device 104 of FIG. 1. The external server 240 of FIG. 7 may be the server 106 of FIG. 1. The hub device 200 may communicate with a plurality of personal devices (e.g., 710, 720, 730), and the number of personal devices (e.g., 710, 720, 730) is not limited. The plurality of personal devices (e.g., 710, 720, 730) may be understood as IoT devices located in a house, but are not limited thereto. The plurality of personal devices (e.g., 710, 720, 730) may be devices related to one information provider (e.g., the first information provider). Although the plurality of personal devices (e.g., 710, 720, 730) may be used by multiple users, in the embodiment of FIG. 7, they can be considered as devices related to one information provider (e.g., the first information provider). The hub device 200 may be understood as a home server communicating with IoT devices, but is not limited thereto. The plurality of personal devices (e.g., 710, 720, 730) may also communicate with each other. The hub device 200 may communicate with the external server 240, and the external server 240 may also be understood as an external device. The 1-1 personal device 710 may include an SLM 711. The 1-2 personal device 720 may include an SLM 721. The 1-3 personal device 730 may include an SLM 731.

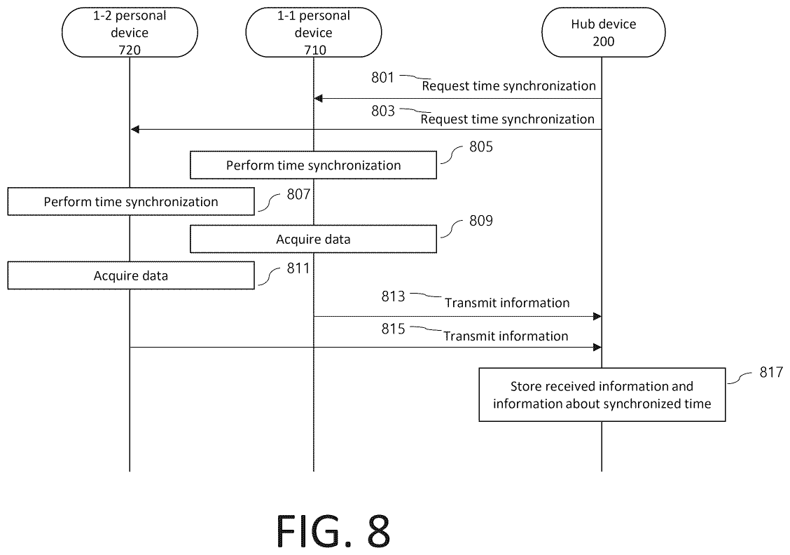

FIG. 8 is a diagram illustrating time synchronization according to various embodiments of the present invention. Referring to FIG. 8, the hub device 200 and the plurality of personal devices (e.g., 710, 720, 730) may perform time synchronization.

In operations 801 and 803, according to various embodiments, the hub device 200 may request time synchronization from the plurality of personal devices (e.g., 710, 720, 730). The hub device 200 may request time synchronization from the plurality of personal devices (e.g., 710, 720, 730) by transmitting information about the synchronization time. For example, the hub device 200 may request time synchronization from the 1-1 personal device 710. The hub device 200 may request time synchronization from the 1-2 personal device 720. The hub device 200 may request time synchronization from the 1-3 personal device 730.

In operations 805 and 807, according to various embodiments, the plurality of personal devices (e.g., 710, 720, 730) may perform time synchronization based on the information about the synchronization time provided from the hub device 200.

In operations 809 and 811, according to various embodiments, the plurality of personal devices (e.g., 710, 720, 730) may acquire data to which time synchronization is applied. For example, the 1-1 personal device 710 may acquire data processed by the SLM 711 and to which time synchronization is applied. The 1-2 personal device 720 may acquire data processed by the SLM 721 and to which time synchronization is applied. The 1-3 personal device 730 may acquire data processed by the SLM 731 and to which time synchronization is applied.

In operations 813 and 815, according to various embodiments, the plurality of personal devices (e.g., 710, 720, 730) may transmit the data (e.g., information) processed by the SLMs (e.g., 711, 721, 731) and to which time synchronization is applied, to the hub device 200.

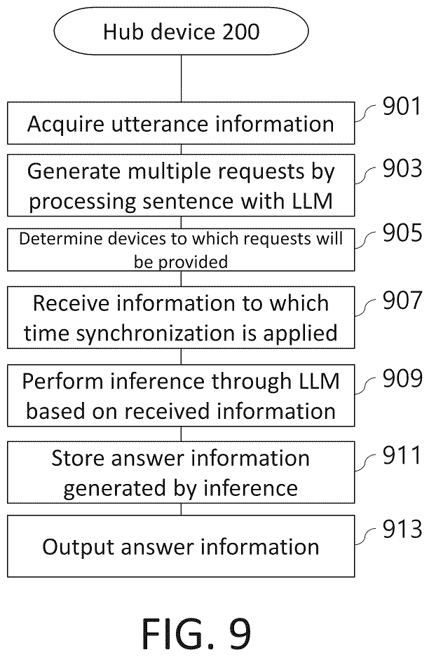

In operation 817, according to various embodiments, the hub device 200 may store the information received through the information transmission operations including operations 813 and 815, and information about the synchronized time, in the memory 340. According to various embodiments, the hub device 200 may perform an inference operation (e.g., operation 909 of FIG. 9) based on the data (e.g., information) processed by the SLMs (e.g., 711, 721, 731) of the plurality of personal devices (e.g., 710, 720, 730) and to which time synchronization is applied.

The embodiments of FIG. 7 and FIG. 8 will be described in more detail with reference to FIG. 9.

FIG. 9 is a diagram illustrating a method of outputting answer information using a plurality of personal devices upon request from an information provider to provide an AI personalization service, according to various embodiments of the present invention. Referring to FIG. 9, the hub device 200 may provide an answer to the information provider based on information obtained through the plurality of personal devices (e.g., 710, 720, 730) according to the request of the information provider (e.g., “Recommend a dish to cook.”).

In operation 901, according to various embodiments, the hub device 200 may obtain first utterance information based on the utterance of the first information provider requesting information provision, through the microphone 350 of the hub device 200. For example, the hub device 200 may receive the utterance “Recommend a dish to cook.” from the first information provider.

In operation 903, according to various embodiments, the hub device 200 may generate a plurality of requests composed in natural language by processing the sentence included in the first utterance information with the LLM 201.

In operation 905, according to various embodiments, the hub device 200 may determine the devices (e.g., 710, 720, 730) to which the plurality of requests composed in natural language will be provided, by analyzing the characteristics of the plurality of requests based on the LLM 201. If the characteristic of the first request among the plurality of requests corresponds to the characteristic of the 1-1 personal device 710, the hub device 200 may transmit the first request to the 1-1 personal device 710. For example, based on the first request being about ingredients, the hub device 200 may transmit the first request to the 1-1 personal device 710, which is a refrigerator capable of providing information about ingredients. If the characteristic of the second request among the plurality of requests corresponds to the characteristic of the 1-2 personal device 720, the hub device 200 may transmit the second request to the 1-2 personal device 720. For example, based on the second request being about dishes cooked in the oven, the hub device 200 may transmit the second request to the 1-2 personal device 720, which is an oven capable of providing information about dishes cooked in the oven. If the characteristic of the third request among the plurality of requests corresponds to the characteristic of the 1-3 personal device 730, the hub device 200 may transmit the third request to the 1-3 personal device 730. For example, based on the third request being about bowel condition, the hub device 200 may transmit the third request to the 1-3 personal device 730, which is a bidet capable of providing information about bowel condition. According to various embodiments, before transmitting the requests, the hub device 200 may search for the plurality of personal devices (e.g., 710, 720, 730) based on a scan operation, and determine whether to transmit the request of operation 905 to the device(s) for which access rights are confirmed among the searched devices. According to various embodiments, the plurality of personal devices (e.g., 710, 720, 730) may recognize the hub device 200 that transmitted the request (e.g., first request, second request, or third request) and perform an input prompting function corresponding to the hub device 200.

In operation 907, according to various embodiments, the hub device 200 may receive information to which time synchronization is applied from the plurality of personal devices (e.g., 710, 720, 730) (e.g., operations 813 and 815 of FIG. 8). For example, the hub device 200 may receive the 1-1 information processed by the SLM 711 of the 1-1 personal device 710 based on the first request composed in natural language and to which time synchronization is applied by the 1-1 personal device 710, from the 1-1 personal device 710. The hub device 200 may receive the 1-2 information processed by the SLM 721 of the 1-2 personal device 720 based on the second request composed in natural language and to which time synchronization is applied by the 1-2 personal device 720, from the 1-2 personal device 720. The hub device 200 may receive the 1-3 information processed by the SLM 731 of the 1-3 personal device 730 based on the third request composed in natural language and to which time synchronization is applied by the 1-3 personal device 730, from the 1-3 personal device 730. For example, the hub device 200 may store the received 1-1 information, 1-2 information, 1-3 information, and information about the synchronized time in the memory 340. For example, the hub device 200 may store information about ingredients, information about recently cooked food, and information about bowel condition in the memory 340. For example, the hub device 200 may store information indicating that the first information provider consumed pumpkin porridge at least twice within about 24 hours after having diarrhea in the memory 340. For example, the hub device 200 may store information indicating that the first information provider ordered milk within 12 hours after the milk in the refrigerator ran out in the memory 340. According to various embodiments, the plurality of personal devices (e.g., 710, 720, 730) may be able to communicate with each other. For example, the plurality of personal devices (e.g., 710, 720, 730) may share the 1-1 information, 1-2 information, and 1-3 information with each other.

In operation 909, according to various embodiments, the hub device 200 may perform inference through the LLM 201 based on the information received in operation 907.

In operation 911, according to various embodiments, the hub device 200 may merge the 1-1 information, the 1-2 information, and the 1-3 information based on the information about the synchronized time, perform inference using the merged information through the LLM 201, and store the answer information generated by the inference in the memory 340. In operation 907, the hub device 200 may share the information stored in the memory 340 and/or the information stored in the memory 340 in operation 911 with the plurality of personal devices (e.g., 710, 720, 730). The information stored in the memory 340 and the information shared with the plurality of personal devices (e.g., 710, 720, 730) can be utilized later for inference by the LLM or SLM of each device (e.g., 200, 710, 720, 730), thereby improving the context understanding and answer accuracy of each device (e.g., 200, 710, 720, 730). For example, the hub device 200 may perform operation 903 later using the information stored in the memory 340 and/or the information stored in the memory 340 in operation 911. For example, the hub device 200 may perform training of the artificial intelligence model using the information stored in the memory 340 and/or the information stored in the memory 340 in operation 911. For example, the information stored in the memory 340 and/or the information stored in the memory 340 in operation 911 may be used as input for training the artificial intelligence model.

In operation 913, according to various embodiments, the hub device 200 may output the answer information. For example, the hub device 200 may output the voice corresponding to the answer information through the speaker 360 of the hub device 200, and/or display the screen corresponding to the answer information through the display 370 of the hub device 200. For example, based on the user utterance “Recommend a dish to cook.” in operation 901, the hub device 200 may output the voice and/or screen “There is squid in the refrigerator. You haven't had stir-fried squid in the last month, and your intestinal condition doesn't seem bad, so I recommend stir-fried squid.” through the speaker 360 and/or the display 370 in operation 913.

According to various embodiments, the hub device 200 may provide the answer information to the information requester. For example, the hub device 200 may store first merged information in the memory 340 by matching the first information related to the first information provider (e.g., the first information of operation 401 and/or the additional information of operation 423) and the answer information (e.g., the answer information of operation 911). Later, the hub device 200 may determine information matching the information search scope requested by the information requester from among the information including the first merged information as information providable to the external server 240, and provide the determined information to the external server 240. The specific operation of providing the determined information to the external server 240 can be explained through the embodiments of FIG. 4 to FIG. 9.

According to various embodiments, a hub device based on Large Language Model (LLM) that performs communication with personal devices based on Small Language Model (SLM) may include a first communication module for short-range wireless communication with the personal devices, a second communication module for communication with an external server, and a memory. The hub device may receive first information processed by the first SLM of the first personal device of the first information provider from the first personal device. The hub device may receive second information processed by the second SLM of the second personal device of the second information provider from the second personal device. The hub device may receive a search request including information about an information search scope specified by an information requester from the external server. The hub device may check whether information matching the information search scope exists among a plurality of information including the first information and the second information. Based on identifying information matching the information search scope among the plurality of information including the first information and the second information, the hub device may transmit, to the external server, data requesting the information requester to pay a fee according to the billing policy and payment method identified by the information matching the information search scope, and a list including the information matching the information search scope. Based on receiving payment information indicating that payment of the fee for the information selected from the list by the information requester is completed, the hub device may provide the selected information to the external server and transmit a message indicating that the selected information has been provided to the external server, to the personal device of the information provider who provided the selected information.

According to various embodiments, the first information may include the first basic information identified through internal data stored in the first personal device and data obtained through a first sensor of the first personal device and processed by the first SLM of the first personal device, the first processed information generated by processing the first basic information by the first SLM of the first personal device, first metadata regarding at least one of the type, quality, acquisition time, acquisition period, or acquisition location of the first basic information, and at least one of the type, quality, processing method, or processing degree of the first processed information, the first license information regarding at least one of the scope of use, authority, usage conditions, redistribution rights, redistribution scope, usage period, expiration period, exclusive ownership status, billing policy, or payment method for the first basic information and the first processed information, set by the first information provider, the first personal information about characteristics of the first information provider including at least one of [list provided in claim 2], and first device information including a first identifier assigned to the first personal device to distinguish the first personal device from other devices. The hub device may determine, based on the first information matching the information search scope, that the first information is information providable to the external server.

According to various embodiments, based on not identifying information matching the information search scope among the plurality of information including the first information and the second information, the hub device may select a device matching the information search scope from among devices including the first personal device and the second personal device, request the selected device to provide additional information corresponding to the information search scope, obtain the additional information from the selected device, and based on the additional information matching the information search scope, provide the additional information to the external server.

According to various embodiments, the first processed information may include 1-1 processed information and 1-2 processed information. The hub device may, based on the metadata, identify a first processing degree indicating the processing degree of the 1-1 processed information and a second processing degree indicating the processing degree of the 1-2 processed information. Based on the license information, the hub device may identify first price information indicating the price set for the 1-1 processed information, second price information indicating the price set for the 1-2 processed information, and third price information indicating the price set for the basic information. Upon selection of the first information from the list by the information requester, the hub device may check the payment information for the first information. Based on the paid fee confirmed by the payment information corresponding to the first price information, the hub device may provide the 1-1 processed information to the external server. Based on the paid fee confirmed by the payment information corresponding to the second price information, the hub device may provide the 1-2 processed information to the external server. Based on the paid fee confirmed by the payment information corresponding to the third price information, the hub device may provide the basic information to the external server.

According to various embodiments, the first personal device includes a 1-1 personal device, a 1-2 personal device, and a 1-3 personal device, and the first information may include 1-1 information provided from the 1-1 personal device, 1-2 information provided from the 1-2 personal device, and 1-3 information provided from the 1-3 personal device.

According to various embodiments, the hub device may request time synchronization to the 1-1 personal device, the 1-2 personal device, and the 1-3 personal device. Through the microphone of the hub device, based on the utterance of the first information provider requesting the provision of information, the hub device may obtain first utterance information. By processing the sentence included in the first utterance information with the LLM, the hub device may generate a plurality of requests composed in natural language. By analyzing the characteristics of the plurality of requests composed in natural language, the hub device may identify the devices to which the plurality of requests will be provided. Based on the characteristics of the plurality of requests, the hub device may transmit a first request to the 1-1 personal device, transmit a second request to the 1-2 personal device, and transmit a third request to the 1-3 personal device. The hub device may receive the 1-1 information processed by the 1-1 SLM of the 1-1 personal device based on the first request composed in natural language and to which time synchronization is applied by the 1-1 personal device, the 1-2 information processed by the 1-2 SLM of the 1-2 personal device based on the second request composed in natural language and to which time synchronization is applied by the 1-2 personal device, and the 1-3 information processed by the 1-3 SLM of the 1-3 personal device based on the third request composed in natural language and to which time synchronization is applied by the 1-3 personal device. The hub device may store the received 1-1 information, 1-2 information, 1-3 information, and information about the synchronized time in the memory. Based on the information about the synchronized time, the hub device may merge the 1-1 information, the 1-2 information, and the 1-3 information. Using the merged information, the hub device may perform inference through the LLM. The hub device may store the answer information generated by the inference in the memory. The hub device may output the voice corresponding to the answer information through the speaker of the hub device or display the screen corresponding to the answer information through the display of the hub device.

According to various embodiments, the 1-1 device is a refrigerator, the 1-2 device is an oven, and the 1-3 device may be a bidet. Based on the utterance of the first information provider requesting a recommendation for food to cook, the hub device may obtain the first utterance information. By processing the sentence included in the first utterance information with the LLM, the hub device may generate the first request requesting information about ingredients in the refrigerator, the second request requesting information about dishes cooked in the oven, and the third request requesting information about the bowel condition of the first information provider. Based on the 1-1 information, the 1-2 information, and the 1-3 information obtained based on the first request, the second request, and the third request, the hub device may determine the dish to recommend to the first information provider. The hub device may store the answer information about the recommended dish in the memory. The hub device may output the voice corresponding to the answer information through the speaker of the hub device or display the screen corresponding to the answer information through the display of the hub device.

According to various embodiments, the hub device may store first merged information by matching the first information related to the first information provider and the answer information. Among the information including the first merged information where the first information and the answer information are matched, the hub device may determine information matching the information search scope requested by the information requester as information providable to the external server.

According to various embodiments, an operation method of a hub device based on Large Language Model (LLM) that performs communication with personal devices based on Small Language Model (SLM) may be provided. The method may include receiving first information processed by the first SLM of the first personal device of the first information provider from the first personal device. The first information may include at least one of first basic information identified based on data of the first personal device, first processed information generated by processing the first basic information, first license information set to restrict the use of the first basic information and the first processed information, or first personal information about characteristics of the first information provider. The method may include receiving second information processed by the second SLM of the second personal device of the second information provider from the second personal device. The second information may include second basic information identified based on data of the second personal device, second processed information generated by processing the second basic information, second license information set to restrict the use of the second basic information and the second processed information, and second personal information about characteristics of the second information provider. The method may include receiving a search request including information about an information search scope specified by an information requester from an external server. The information search scope may include at least one of the type of information to be used, scope of use, authority, usage conditions, required frequency, usage period, quality, redistribution rights, redistribution scope, exclusive ownership status, billing policy, payment method, or information about characteristics of the information provider. The method may include checking whether information matching the information search scope exists among a plurality of information including the first information and the second information. Based on identifying information matching the information search scope among the plurality of information including the first information and the second information, the method may include transmitting, to the external server, data requesting the information requester to pay a fee according to the billing policy and payment method identified by the information matching the information search scope, and a list including the information matching the information search scope. Based on receiving payment information indicating that payment of the fee for the information selected from the list by the information requester is completed, the method may include providing the selected information to the external server. The selected information may include information corresponding to one information provider or information corresponding to multiple information providers. The method may include transmitting a message indicating that the selected information has been provided to the external server, to the personal device of the information provider who provided the selected information.

The term “module” or “˜ unit” used in this document includes a unit configured of hardware, software, or firmware, and may be used interchangeably with terms, for example, logic, logic block, part, and circuit. The “module” or “˜ unit” may be an integrally configured component, or a minimum unit or a part thereof that performs one or more functions. The “module” or “˜ unit” may be implemented mechanically or electronically, and may include, for example, an application-specific integrated circuit (ASIC) chip, field-programmable gate arrays (FPGAs), or a programmable logic device known or to be developed in the future to perform certain operations, and may be executed by the processor 120. At least some of devices (e.g., modules or functions thereof) or methods (e.g., operations) according to various embodiments may be implemented as instructions stored in a computer-readable storage medium (e.g., the memory 130) in the form of a program module. When the instructions are executed by a processor (e.g., the processor 120), the processor may perform a function corresponding to the instructions. The computer-readable recording medium may include a hard disk, a floppy disk, a magnetic medium (e.g., a magnetic tape), an optical recording medium (e.g., a CD-ROM, a DVD), a magneto-optical medium (e.g., a floptical disk), a built-in memory, and the like. The instructions may include codes generated by a compiler or codes executable by an interpreter. A module or a program module according to various embodiments may include at least one or more of the components described above, omit some of the components, or further include other components. Operations performed by a module, a program module, or other components according to various embodiments may be executed sequentially, in parallel, repeatedly, or heuristically, or at least some of the operations may be executed in a different order or omitted, or other operations may be added.

Furthermore, the embodiments disclosed in this document are presented for the purpose of explanation and understanding of the disclosed technical contents, and do not limit the scope of the present disclosure. Therefore, the scope of the present disclosure should be interpreted to include all modifications or various other embodiments based on the technical spirit of the present disclosure.

What is claimed is:

1. A hub device operating based on Large Language Model (LLM), the hub device performing communication with personal devices operating based on Small Language Model (SLM),
the hub device comprising:
a first communication module for short-range wireless communication with the personal devices;
a second communication module for communication with an external server; and
a memory,
wherein the hub device is configured to:
receive, through the first communication module, first information processed by a first SLM of a first personal device of a first information provider, from the first personal device, wherein the first information includes at least one of first basic information identified based on data of the first personal device, first processed information generated by processing the first basic information, first license information set to restrict use of the first basic information and the first processed information, or first personal information about characteristics of the first information provider;
receive, through the first communication module, second information processed by a second SLM of a second personal device of a second information provider, from the second personal device, wherein the second information includes at least one of second basic information identified based on data of the second personal device, second processed information generated by processing the second basic information, second license information set to restrict use of the second basic information and the second processed information, or second personal information about characteristics of the second information provider;
receive, through the second communication module, a search request including information about an information search scope specified by an information requester from the external server, wherein the information search scope includes at least one of a type of information to be used, a scope of use, authority, usage conditions, a required frequency, a usage period, quality, redistribution rights, a redistribution scope, exclusive ownership status, a billing policy, a payment method, or information about characteristics of an information provider;
check whether information matching the information search scope exists among a plurality of information including the first information and the second information;
based on identifying information matching the information search scope among the plurality of information including the first information and the second information, transmit, to the external server, data requesting the information requester to pay a fee according to a billing policy and a payment method identified by the information matching the information search scope, and a list including the information matching the information search scope;
based on receiving payment information indicating that payment of a fee for information selected from the list by the information requester is completed, provide the selected information to the external server, wherein the selected information includes information corresponding to one information provider or information corresponding to a plurality of information providers; and
transmit a message indicating that the selected information has been provided to the external server, to a personal device of an information provider who provided the selected information.

2. The hub device of claim 1,
wherein the first information comprises:
the first basic information identified through internal data stored in the first personal device and data obtained through a first sensor of the first personal device, and processed by the first SLM of the first personal device;
the first processed information generated by processing the first basic information by the first SLM of the first personal device;
first metadata regarding at least one of a type, quality, an acquisition time, an acquisition period, or an acquisition location of the first basic information, and at least one of a type, quality, a processing method, or a processing degree of the first processed information;
the first license information regarding at least one of a scope of use, authority, usage conditions, redistribution rights, a redistribution scope, a usage period, an expiration period, exclusive ownership status, a billing policy, or a payment method for the first basic information and the first processed information, set by the first information provider;
the first personal information about characteristics of the first information provider, including at least one of gender, age, nationality, residence, health status, medical history, prescription records, marital status, family information, SNS accounts, login information, online activity records, educational background, grades, school records, scholarship information, occupation, position, career, income, company location, owned vehicle information, loan history, credit card usage history, tax payment history, hobbies, interests, purchase history, consumption patterns, religion, race, criminal record, or legal dispute details; and
first device information including a first identifier assigned to the first personal device to distinguish the first personal device from other devices,
wherein the hub device is further configured to: determine, based on the first information matching the information search scope, that the first information is information providable to the external server.

3. The hub device of claim 2,
wherein the hub device is further configured to:
based on not identifying information matching the information search scope among the plurality of information including the first information and the second information, select a device matching the information search scope from among devices including the first personal device and the second personal device;
request the selected device to provide additional information corresponding to the information search scope;
obtain the additional information from the selected device; and
based on the additional information matching the information search scope, provide the additional information to the external server.

4. The hub device of claim 2,
wherein the first processed information comprises 1-1 processed information and 1-2 processed information, and
wherein the hub device is further configured to: based on the metadata, identify a first processing degree indicating a processing degree of the 1-1 processed information, and a second processing degree indicating a processing degree of the 1-2 processed information;
based on the license information, identify first price information indicating a price set for the 1-1 processed information, second price information indicating a price set for the 1-2 processed information, and third price information indicating a price set for the basic information;
upon selection of the first information from the list by the information requester, check the payment information for the first information;
based on a paid fee confirmed by the payment information corresponding to the first price information, provide the 1-1 processed information to the external server;
based on the paid fee confirmed by the payment information corresponding to the second price information, provide the 1-2 processed information to the external server; and
based on the paid fee confirmed by the payment information corresponding to the third price information, provide the basic information to the external server.

5. The hub device of claim 1,
wherein the first personal device comprises a 1-1 personal device, a 1-2 personal device, and a 1-3 personal device,
wherein the first information comprises 1-1 information provided from the 1-1 personal device, 1-2 information provided from the 1-2 personal device, and 1-3 information provided from the 1-3 personal device, and
wherein the hub device is further configured to:
request time synchronization to the 1-1 personal device, the 1-2 personal device, and the 1-3 personal device;
obtain, through a microphone of the hub device, first utterance information based on an utterance of the first information provider requesting provision of information;
generate a plurality of requests composed in natural language by processing a sentence included in the first utterance information with the LLM;
identify devices to which the plurality of requests will be provided by analyzing characteristics of the plurality of requests composed in natural language;
based on the characteristics of the plurality of requests, transmit a first request to the 1-1 personal device, transmit a second request to the 1-2 personal device, and transmit a third request to the 1-3 personal device;
receive the 1-1 information processed by a 1-1 SLM of the 1-1 personal device based on the first request composed in natural language and to which time synchronization is applied by the 1-1 personal device, the 1-2 information processed by a 1-2 SLM of the 1-2 personal device based on the second request composed in natural language and to which time synchronization is applied by the 1-2 personal device, and the 1-3 information processed by a 1-3 SLM of the 1-3 personal device based on the third request composed in natural language and to which time synchronization is applied by the 1-3 personal device;
store the received 1-1 information, the 1-2 information, the 1-3 information, and information about a synchronized time in the memory;
merge the 1-1 information, the 1-2 information, and the 1-3 information based on the information about the synchronized time;
perform inference through the LLM using the merged information; store answer information generated by the inference in the memory; and
output a voice corresponding to the answer information through a speaker of the hub device, or display a screen corresponding to the answer information through a display of the hub device.

6. The hub device of claim 5,
wherein the 1-1 device is a refrigerator,
wherein the 1-2 device is an oven,
wherein the 1-3 device is a bidet, and
wherein the hub device is further configured to:
obtain the first utterance information based on the utterance of the first information provider requesting a recommendation for food to cook;
generate the first request requesting information about ingredients in the refrigerator, the second request requesting information about dishes cooked in the oven, and the third request requesting information about a bowel condition of the first information provider, by processing the sentence included in the first utterance information with the LLM;
determine a dish to recommend to the first information provider based on the 1-1 information, the 1-2 information, and the 1-3 information obtained based on the first request, the second request, and the third request;
store the answer information about the recommended dish in the memory; and
output the voice corresponding to the answer information through the speaker of the hub device, or display the screen corresponding to the answer information through the display of the hub device.

7. An operation method of a hub device operating based on Large Language Model (LLM), the hub device performing communication with personal devices operating based on Small Language Model (SLM),
the method comprising:
receiving first information processed by a first SLM of a first personal device of a first information provider, from the first personal device, wherein the first information includes at least one of first basic information identified based on data of the first personal device, first processed information generated by processing the first basic information, first license information set to restrict use of the first basic information and the first processed information, or first personal information about characteristics of the first information provider;
receiving second information processed by a second SLM of a second personal device of a second information provider, from the second personal device, wherein the second information includes at least one of second basic information identified based on data of the second personal device, second processed information generated by processing the second basic information, second license information set to restrict use of the second basic information and the second processed information, or second personal information about characteristics of the second information provider;
receiving, from an external server, a search request including information about an information search scope specified by an information requester, wherein the information search scope includes at least one of a type of information to be used, a scope of use, authority, usage conditions, a required frequency, a usage period, quality, redistribution rights, a redistribution scope, exclusive ownership status, a billing policy, a payment method, or information about characteristics of an information provider;
checking whether information matching the information search scope exists among a plurality of information including the first information and the second information;
based on identifying information matching the information search scope among the plurality of information including the first information and the second information, transmitting, to the external server, data requesting the information requester to pay a fee according to a billing policy and a payment method identified by the information matching the information search scope, and a list including the information matching the information search scope;
based on receiving payment information indicating that payment of a fee for information selected from the list by the information requester is completed, providing the selected information to the external server, wherein the selected information includes information corresponding to one information provider or information corresponding to a plurality of information providers; and
transmitting a message indicating that the selected information has been provided to the external server, to a personal device of an information provider who provided the selected information.
